(19) United States
(12) Patent Application Publication
(10) Pub. No.: US 2024/0351302 A1
(43) Pub. Date: Oct. 24, 2024

(54) HONEYCOMB CORE PLATE AND PROCESSING METHOD THEREOF

(71) Applicant: Hong Jie FU, Shenzhen (CN)

(72) Inventor: Hong Jie FU, Shenzhen (CN)

(21) Appl. No.: 18/251,163

(22) PCT Filed: Dec. 2, 2022
(86) PCT No.: PCT/CN2022/136306

§ 371 Date: Apr. 28, 2023

(30) Foreign Application Priority Data
Nov. 14, 2022 (CN) 202211427540.9

(51) Int. Cl. B32B 3/12; B29D 99/00; B29K 23/00; B32B 3/30; B32B 27/08; B32B 27/32

(52) U.S. Cl. CPC B32B 3/12; B29D 99/0089; B32B 3/30; B32B 27/08; B32B 27/32; B29K 2023/12

(57) ABSTRACT

The application relates to a honeycomb core plate and a processing technique thereof, wherein the processing technique includes the following steps: folding: fixing the raw material plate on the mould, and folding to make the surface of the raw material plate have a plurality of folded structures with the same spacing and the same direction; grooving: cutting a plurality of uniformly distributed grooves on the surface of the folded structure; coating film: coating film on the surface of the folded structure of the raw material plate; docking: inserting the folded structures of the two raw material plates into each other, so that the grooves of the two folded structures are connected in a cross way to form the honeycomb core plate.

### CROSS REFERENCE

This application is a national phase entry of PCT international phase patent application No. PCT/CN2022/136306, with an international filing date of Dec. 2, 2022, which is based upon and claims priority benefits to Chinese Patent Application No. 202211427540.9, filed on Nov. 14, 2022, the contents of which are incorporated herein by reference.

### TECHNICAL FIELD

The present disclosure belongs to the field of processing of honeycomb core plate, and in particular relates to a honeycomb core plate and the processing method thereof.

### BACKGROUND

Honeycomb core plate is a kind of low material consumption, high specific strength and specific stiffness, light weight plate, which has excellent cushioning and vibration isolation function as well as thermal insulation and sound insulation performance, and is widely used in construction, furniture manufacturing and packaging industries. The structure of the existing honeycomb core plate is formed by bonding an upper plate and a lower plate with a honeycomb core material in the middle. The structure of honeycomb core material is different, there are honeycomb, cylindrical and polygonal.

The main processes of honeycomb core are suction plastic, hot pressing and injection molding. For example, a commonly used honeycomb core uses suction plastic process, processing the obverse and the reverse side by suction plastic after heating the honeycomb core material, and then bonding two thin plates through the glue, and finally cutting. However, the shortcoming of this process is it only can process thin honeycomb core material, such honeycomb core structure is relatively soft, low strength, but low cost and good core elasticity, which is widely used in packaging, but cannot be used in other fields.

The process of cylindrical honeycomb core plate is that, heating polypropylene particles, extruding the polypropylene particles into round tubes, then arranging the round tubes, baking the round tubes at high temperature into honeycomb shape, finally, cutting it into honeycomb cores, and bonding plates on the upper and lower surfaces to form the honeycomb core plate. This kind of honeycomb core plate has high strength and good index in all aspects, but the process is complicated, the cost is high, and the market price is high.

For example, patient WO2008/141688A2 discloses an elastic honeycomb plate, a production process and a production device thereof, wherein the honeycomb core material is formed by processing a polypropylene plate by suction plastic into a plurality of arranged semi-honeycomb shapes, then folding the polypropylene plate in the middle and then performing hot melt bonding to form a plurality of neatly arranged finished honeycomb shapes, which form a hexagonal honeycomb core, then bonding a layer of thermoplastic polymer, fiber composite material or plastic deformation paper or metal sheet on the upper and lower surfaces of the honeycomb core to form the honeycomb plate. This honeycomb core plate is flexible, but the process is complicated, and it needs to be folded and bonded after suction plastic.

The defects of the processing method of the mentioned honeycomb core plate are that the processing method is complex and the cost is high, and the product structure is completely the composite of the upper plate, the lower plate and the honeycomb core material.

### SUMMARY

In order to overcome the above defects in the existing technology, the present application provides a honeycomb core plate and the processing method thereof. The honeycomb core plate has a simple structure, is simple to process, and the cost is greatly reduced, which is realized by the following technical scheme.

A processing method of a honeycomb core plate, which comprises the following steps:
folding: fixing the raw material plate on the mould, and folding it to make the surface of the raw material plate have a plurality of folded structures with the same spacing and the same direction;
grooving: cutting a plurality of uniformly distributed grooves on the folded structure;
coating film: coating film on the surface of the folded structure of the raw material plate;
docking: inserting the folded structures of the two raw material plates into each other, so that the grooves of the two folded structures are connected in a cross way to form the honeycomb core plate.

The honeycomb core plate comprises a first raw material plate and a second raw material plate, wherein a plurality of parallel first folded structures are arranged on the first raw material plate: first grooves are formed in the first folded structures at intervals; a plurality of parallel second folded structures are arranged on the second raw material plate: second grooves are formed in the second folded structures at intervals; and the folded structures of the first raw material plate and the second raw material plate are relatively inserted, so that the first grooves and the second grooves are mutually inserted and engaged to form the honeycomb core plate.

The application has the advantages of simple processing and greatly reduced processing cost. The honeycomb core board has simple structure and is low cost.

### BRIEF DESCRIPTION OF THE DRAWINGS

FIG. 1 is a process flow diagram of a first embodiment of the present application.

FIG. 2 is a process flow diagram of a second embodiment of the present application.

FIG. 3 is a schematic diagram of a creasing process according to the first embodiment of the present application.

FIG. 4 is a schematic diagram of a folding process according to the first embodiment of the present application.

FIG. 5 is a schematic diagram of a grooving process according to the first embodiment of the present application.

FIG. 6 is a schematic diagram of a coating film process according to the first embodiment of the present application.

FIG. 7 is a schematic diagram of a docking process according to the first embodiment of the present application.

FIG. 8 is a schematic diagram of the process flow of the first embodiment of the present application after completion.

FIG. 9 is a schematic structural view of a honeycomb core plate according to the first embodiment of the present application.

FIG. 10 is a schematic view of an exploded structure of a honeycomb core plate according to the first embodiment of the present application.

FIG. 11 is a schematic structural view of a honeycomb core plate according to the second embodiment of the present application.

FIG. 12 is a schematic view of an exploded structure of a honeycomb core plate according to the second embodiment of the present application.

### DETAILED DESCRIPTION OF THE EMBODIMENTS

The present application will be further described below with reference to the embodiments, which are only part of the embodiments of the present application, and are only used for explaining the present application, and do not constitute any limitation on the scope of the present application.

The flow diagrams shown in the figures are merely illustrative and do not necessarily include all of the contents and operations/steps, nor do they necessarily have to be performed in the order described. For example, some operations/steps may also be decomposed, combined, or partially combined, and thus the actual execution order may be changed according to actual situations.

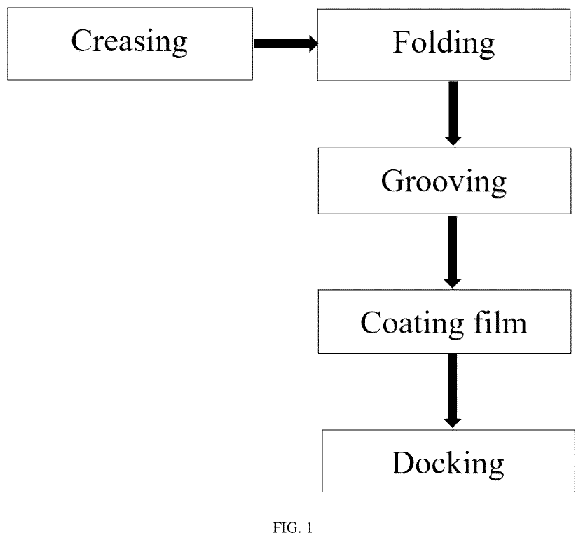

As shown in FIG. 1, in a first embodiment of the present application, a processing method of a honeycomb core plate, which comprises the following steps:
folding: folding the raw material plate through a mould to ensure that the surface of the raw material plate has a plurality of folded structures with the same spacing and the same direction;
grooving: cutting a plurality of uniformly distributed grooves on the folded structure;
coating film: coating film on the surface of the folded raw material plate, and coating the film on the surface of the folded structure;
docking: inserting the folded structures of the two raw material plates into each other, so that the grooves of the two folded structures are connected in a cross way to form the honeycomb core plate.

In the embodiment of the present application, the plate may be made of various materials, such as polypropylene plate, cardboard, metal sheet or other sheet plastic plate, rubber plate, etc. The present application takes polypropylene as an example, and polypropylene is the most widely used material of the honeycomb core plate in the art.

As shown in FIG. 4, a whole polypropylene plate 10 is placed on a profiling mould 30, and the polypropylene plate is shaped along the profiling mould to present a plurality of folded structures with the same spacing, and the spacing of the folded structures is the same.

The profiling mould is characterized in that a plurality of metal sheets 31 are arranged on a flat plate at intervals, and the metal sheets are parallel and vertical to the flat plate. Taking the bottom edge of the flat plate as a reference, the orientation of the metal sheets is inclined, parallel or vertical within the range of 0-90 degrees.

The metal sheet 31 is provided with a plurality of strip-shaped grooves 32 with the same spacing.

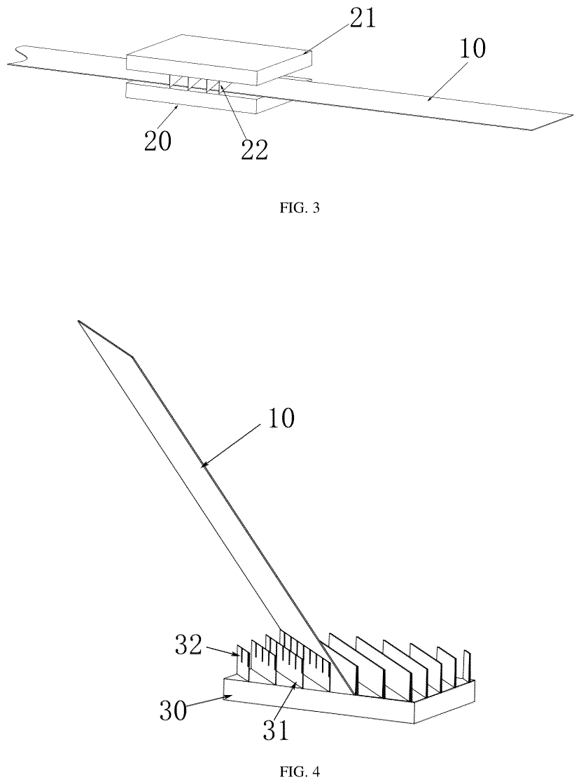

As shown in FIG. 3, the method further comprises a step of pressing a crease before folding, specifically: Pressing the creases on the surface of the polypropylene plate by means of mould (20, 21) so the polypropylene plate can be folded along the creases. The creases may be formed in the surface of the polypropylene plate by rolling or by using the dies 22 of a precision punch press. The creases are parallel shallow groove-like structures for easy folding. The width and spacing of the metal sheet should be taken into account when determining the spacing of the creases.

As shown in FIG. 5, grooving: using cutting to groove, and cutting grooves on the folded structure by a blade or saw blade 41 of a cutting mould 40 cooperating with the strip-shaped groove 32. The depth of the groove is about half the height of the folded structure, and the width of the groove is consistent with the thickness of the folded structure. The thickness of the folded structure is 2 times the thickness of the polypropylene plate, and the height of the folded structure is adjusted as required.

In other embodiments of the present application, hot melt grooving may be employed, which is suitable for polypropylene plate.

After grooving, a plurality of grooves 102 are formed on the folded structure 101.

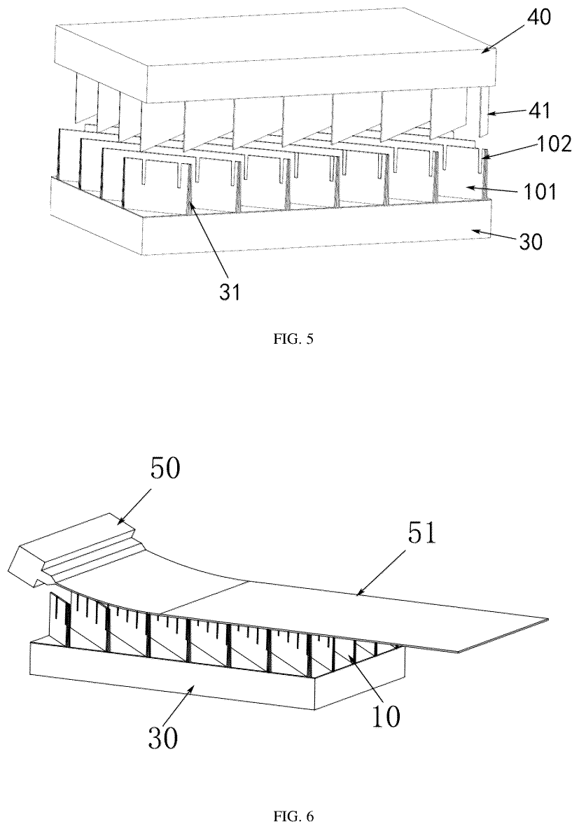

As shown in FIG. 6, coating film: a layer of polypropylene film 51 is coated on the surface of the polypropylene plate by a coating film device 50 to cover the side with the folded structure. The coating film can make the two polypropylene plates be bonded together when they docking, and the polypropylene film can be replaced by other films with a bonding function.

In other embodiments of the present application, the polypropylene film may be replaced with glue for bonding the upper and lower folded raw material plates together to form a honeycomb core plate having upper and lower surfaces and a honeycomb layer.

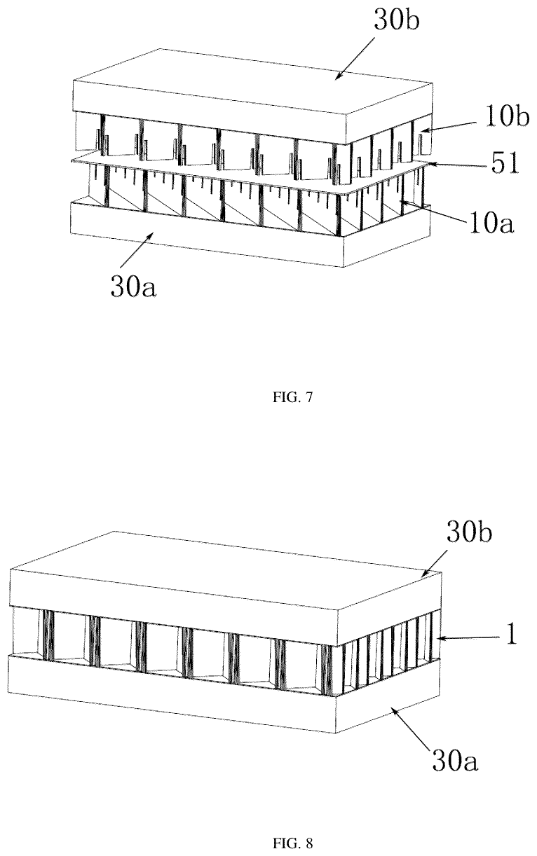

As shown in FIG. 7, docking: press the two polypropylene plates (10a, 10b) processed according to the above steps in opposite directions to insert the grooves on the folded structure in each other.

Specifically, the two profiling moulds (30a, 30b) are directly apply with pressure in opposite directions, so that the polypropylene plates (10a, 10b) on the two profiling moulds (30a, 30b) move relatively and are inserted into the grooves of the folded structure, and the polypropylene films 51 make the polypropylene plates (10a, 10b) gluing together to form the honeycomb core plate.

As shown in FIG. 8, the upper and lower profiling mould (30a, 30b) are removed to form the honeycomb core plate 1, which can be used as a honeycomb plate, and also can be used as a honeycomb core, and the upper and the lower surfaces are attached with the plate material to increase the strength.

The folded structures of the two polypropylene plates are connected in a staggered manner through the grooves so as to form a plurality of rhombus, square or rectangular shapes, and the folded structures are connected in a staggered manner so as to form a honeycomb structure with a plurality of continuous rhombus, square or rectangular shapes, which makes the honeycomb core have a stable structure, so that the strength of the honeycomb plate having the honeycomb core is high.

In another embodiment of the present application, the folding may be performed in a suction plastic manner, the polypropylene plate is placed on a mould to be preheated, and then the folded structure is presented in a vacuum adsorption manner. Then, the honeycomb core plate is formed through the processes of grooving, coating film and docking (which are consistent with the flow of the first embodiment).

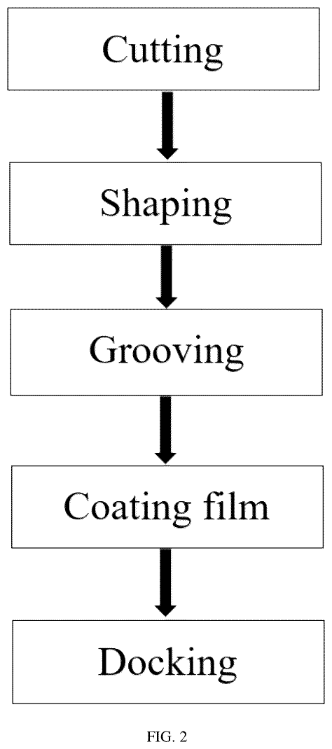

As shown in FIG. 2, which is a process flow chart of the second embodiment of the present application, and taking a polypropylene plate as an example, the steps are as follows:
Cutting: fixing the polypropylene plate on the mould, and cutting the plate by the cutting die, so that the raw material plate is uniformly distributed with a plurality of parallel cutting structures, when determining the cutting spacing should take the width and spacing of the metal sheet into account. In addition to the cutting die, the cutting can also be carried out by a knife roller.
Shaping: shaping the cutting part along the blade to make the surface of the cutting part have a plurality of folded structures with the same spacing and the same direction, that is, the cut polypropylene plate is placed on the profiling mould 30, and when the polypropylene plate is adsorbed by the vacuum adsorption device on the profiling mould 30, the cutting part is shaped along the blade to form a vertical cutting structure, which is equivalent to a folded structure;
Grooving: cutting a plurality of uniformly distributed grooves on the cutting structure/folded structure;
Coating film: coating film on the surface of the grooved raw material plate;
Docking: along the opposite direction of the folded structure of the two plates, the grooves on the folded structure are docked to form the honeycomb core plate.

In the embodiment of the present application, the metal sheet of the mould in the first embodiment is replaced by a blade, which is suitable for cutting the plate to form a folded structure.

Other processes except cutting and folding are the same as those of the first embodiment, and the description thereof is not repeated here.

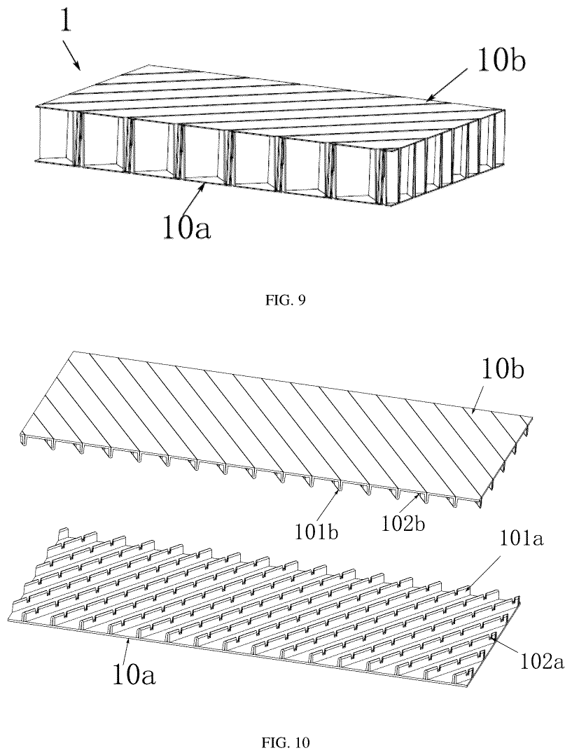

As shown in FIGS. 9-10, the honeycomb core plate 1 processed by the process of the first embodiment comprises a first plate 10a and a second plate 10b, wherein the first plate is provided with a plurality of parallel first folded structures 101a, the first folded structures are provided with first grooves 102a at intervals, the second plate is provided with a plurality of parallel second folded structures 101b, the second folded structures are provided with second grooves 102b at intervals, and the first plate 10a and the second plate 10b are docked, so that the first groove 102a and the second groove 102b are inserted and engaged with each other to form the honeycomb core plate 1 which can also be used as a core.

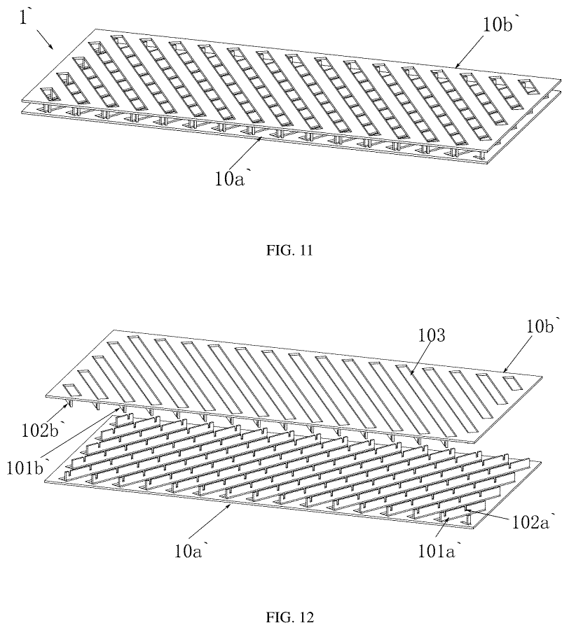

As shown in FIGS. 11-12, the honeycomb core plate 1′ processed by the process of the second embodiment comprises a first plate 10a′ and a second plate 10b′, wherein a plurality of parallel first folded structures 101a′ are cut on the first plate, and first grooves 102a′ are arranged on the first folded structures 101a′ at intervals: a plurality of parallel second folded structures 101b′ are cut on the second plate, and the second grooves 102b′ are arranged on the second folded structures at intervals; The first plate and the second plate are docked, so that the first groove 102a′ and the second groove 102b′ are inserted and engaged with each other to form the honeycomb core plate.

a plurality of rectangular through holes 103 are formed after cutting, which can be used as a honeycomb core plate in a special scene, such as packaging materials required breathability.

Compared with the related art, the manufactured honeycomb core plate can be used as a honeycomb core plate or a honeycomb core. Compared with the structure of the upper plate, the honeycomb core and the lower plate in the related art, the honeycomb core plate in the present application has a more simplified structure, that is, a honeycomb core plate formed by folding/cutting the upper and lower raw material plates.

The above is only a preferred embodiment of the present application, and is not intended to limit the present application. For those skilled in the art, the present application may have various modifications and variations. Any modification, equivalent replacement and improvement within the spirit and principle of the present application shall be included in the protection scope of the present application.

What is claimed is:

1. A method for processing a honeycomb core plate, comprising:
folding: fixing a raw material plate on a mould, and folding to make a surface of the raw material plate have a plurality of folded structures with a same spacing and a same direction;
grooving: cutting a plurality of uniformly distributed grooves on the folded structure;
coating film: coating film on a surface of the folded structure of the raw material plate;
docking: inserting the folded structures of the two raw material plates into each other, so that the grooves of the two folded structures are connected in a cross way to form the honeycomb core plate.

2. The method of claim 1, wherein the mould is used to press a crease on the surface of the raw material plate before folding, and the folded structures are formed along the crease on the raw material plate during folding.

3. The method of claim 1, wherein the folding can be replaced by: using a plastic suction process to form a plurality of folded structures with the same spacing and the same direction on the surface of the raw material plate.

4. The method of claim 1, wherein the folding can be replaced by cutting and shaping, and the cutting and shaping steps are as follows:
cutting: fixing the raw material plate on the mould, and cutting the plate by a cutting die, so that a plurality of parallel cutting structures is uniformly distributed on the raw material plate;
shaping: shaping the cutting structure along a blade, so that the surface of the cutting structure has a plurality of folded structures with the same spacing and the same direction.

5. A honeycomb core plate, comprising a first raw material plate and a second raw material plate, wherein the first raw material plate is provided with a plurality of parallel first folded structures, the first folded structures are provided with first grooves at intervals, the second raw material plate is provided with a plurality of parallel second folded structures, the second folded structures are provided with second grooves at intervals, and the folded structures of the first raw material plate and the second raw material plate are relatively inserted, so that the first groove and the second groove are mutually inserted and engaged to form the honeycomb core plate.

6. The honeycomb core plate of claim 5, wherein when the first groove and the second groove are inserted and engaged with each other, a plurality of rhombic, square or rectangular cross structures are formed between the first raw material plate and the second raw material plate.
